(19) United States
(12) Patent Application Publication
(10) Pub. No.: US 2002/0174943 A1
(43) Pub. Date: Nov. 28, 2002

(54) Decal for application to a geological or cement formation and method of applying same

(76) Inventor: John Andrews, Berwyn, PA (US)

Correspondence Address: CLIFFORD G. FRAYNE, Suite 7A, 136 Drum Point Road, Brick, NJ, 08723, US

(21) Appl. No.: 09/864,770

(22) Filed: May 25, 2001

(51) Int. Cl. B44C 1/00

(52) U.S. Cl. 156/240; 156/249; 156/230; 156/289

(57) ABSTRACT

A decorative or informative decal adherable to a grainy or textured surface, including that of a geological formation, such as a rock or a concrete structure, the decal defined by a first layer of water permeable transfer paper overlaid with a second layer release coat which is overlaid with a third layer of inorganic metallic color oxides in an oil medium formed in a decorative shape or informational text which is overlaid with a fourth layer of cover coat. The surface to which the decal is applied is first wet with a suitable solvent, the decal is wetted such that the water permeable transfer paper and release coat is removed and the third layer of inorganic metallic color oxides in an oil medium is juxtaposed the surface of the geological formation or concrete, and smoothed to conform to the surface. A portion of the cover coat and oil medium reacts with the solvent so as to dissolve and become tacky and forms the adhesive and adheres to the rock or concrete and dries, thereby positioning the decal.

### BACKGROUND OF THE INVENTION

1. Field of the Invention

The present invention relates to decals, and in particular, to a decal which can be applied to a geological or cement formation such as a rock or stone or concrete structure.

2. Description of the Prior Art

Decals which are well-known in the art are multi-layered applications which can be decorative or informative. In one embodiment a decal consists of an information or decorative layer having an adhesive backing and a removable carrier layer which is stripped away prior to application of the decal. In another embodiment instead of an adhesive coat, there is a coat which reacts with water and sets after the decal has been positioned on the desired surface. Other embodiments of decal construction are also available. However, the shortcomings of all decal embodiments heretofore has been that the surface to which the decal is applied must normally be a smooth, even surface.

Applicant has developed a decal which has application to uneven surfaces and even surfaces which might be characterized as grainy or textured. In particular, Applicant has developed a decal which can be constructed with a decorative or informative layer, which decal can be transferred to the surface of a geological formation such as a rock or stone or to a concrete or cement structure. A decal thus produced can be used to provide decorative applications to rocks which may already be being used in a decorative formation, such as a garden rock or walkway rock, and it can also be used to decorate concrete structures such as highway overpasses, or building hallways or exteriors.

### OBJECTS OF THE INVENTION

An object of the present invention is to provide for a novel decal which can be applied to and adhere to a grainy, textured surface, such as concrete.

A further object of the present invention is to provide for a novel decal which can be applied to and adhere to a geological formation, such as a rock

A still further object of the present invention is to provide for a novel decal which will not deteriorate as a result of UV light.

A still further object of the present invention is to provide for a novel decal and method of applying same so as to permit one to decorate the surface of a geological formation, such as a rock or a concrete structure.

A still further object of the present invention is to provide a novel decal which will not deteriorate or release under the influence of fresh, salt or chlorinated water.

### SUMMARY OF THE INVENTION

A decorative or informative decal adherable to an uneven grainy or textured surface, including that of a geological formation, such as a rock or a concrete structure, the decal defined by a first layer of water permeable transfer paper overlaid with a second layer release coat which is overlaid with a third layer of inorganic metallic color oxides in an oil medium formed in a decorative shape or informational text which is overlaid with a fourth layer of cover coat. The surface to which the decal is applied is first wet with a suitable solvent, the decal is wetted such that the water permeable transfer paper and release coat is removed and the cover coat and inorganic metallic color oxides in medium are juxtaposed the surface of the geological formation, and smoothed to conform to the surface. A portion of the cover coat and oil medium reacts with the solvent so as to dissolve and become tacky and adheres to the rock and dries, thus positioning the decal.

### BRIEF DESCRIPTION OF THE DRAWINGS

These and other objects of the present invention will become apparent, particularly when taken in light of the following illustrations wherein:

FIG. 1 is a schematic cross-section of the decorative or informative decal; and

FIG. 2 is a schematic cross-section of the application phase of the decal as applied to the surface of the geological formation.

FIG. 3 is a schematic cross-section of the decal in situ.

### DETAILED DESCRIPTION OF THE DRAWINGS

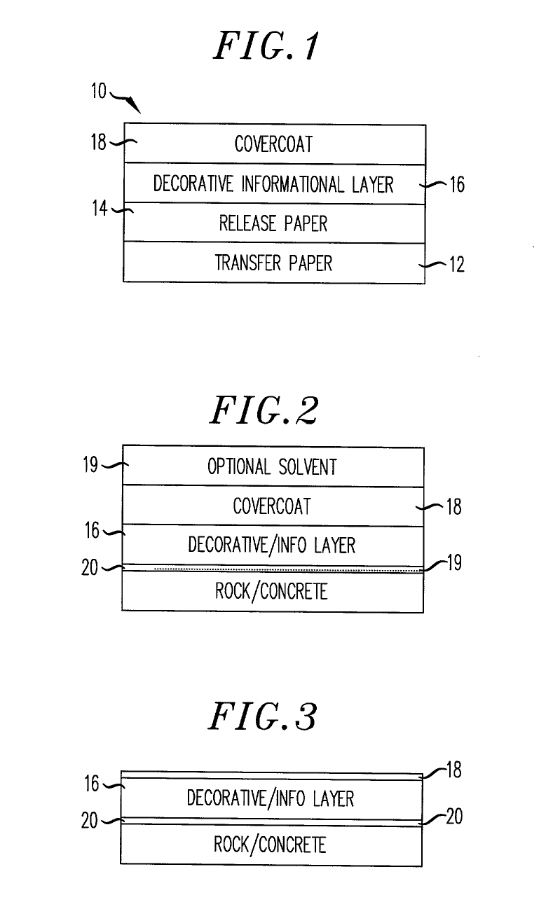

FIG. 1 is a schematic edge view of the decal 10 of the present invention. The decal comprises a first layer 12 of water permeable transfer paper which serves the purpose of providing a base upon which the other layers are printed during the manufacturing process. The water permeable transfer paper layer 12 is overlaid with a release coat layer 14 which aids in the separation of the water permeable transfer paper 12 and release coat 14 from the actual decal during the application phase.

The release coat layer 14 is overlaid with the actual decorative or informational layer 16. The decorative or informational layer 16 is then overlaid with a cover coat 18.

The water permeable paper layer comprises any suitable paper having a high rate of water absorption. Preferably the paper stock is 8 mil, 100 pound stock, which paper adds stability during the coating process.

The release coat layer 14 is any suitable water soluble release agent such as quilone, or gum arabic.

The decorative or informational layer is comprised of inorganic, metallic color oxides intimately mixed in a suitable oil medium and then formed into the information text or decorative design at a plurality of printing stations with which the transfer paper is in registration.

A portion of the cover coat 18 is designed to react with a solvent 19 which is first applied to the geological formation or concrete to wet it. The solvent of choice is turpentine, but can include acetone, toluene, any suitable ethers or alcohol, butyl cellosolve, cellosolve acetate, and EB acetate. As such, the cover coat or carrier coat could be comprised of an acrylic cover coat, polyester cover coat, polyurethane cover coat or nitro cellulose cover coat.

In the application of the decal (FIG. 2), the geological formation or concrete is cleaned of any loose dirt or dust. The surface 20 is then wetted briefly with one of the aforementioned solvents 19. The decal is then wetted such that the water permeable paper layer 12 and release coat layer 14 are removed. The inorganic metallic color oxides and medium layer is then applied to the geological formation or rock surface 20 and smoothed into place. The cover coat 18 and medium and wetting solvent 19 react such that a portion of the cover coat and medium is dissolved with the solvent to a tacky state and dries and adheres 20 the decorative or informational layer 16 to the rock or concrete (FIG. 3). The decorative or informational layer 16 comprised of inorganic metallic oxides is unaffected by UV light and is water proof after application. A portion of the cover coat 18 remains overlaying the inorganic metallic color oxide layer. In the application phase an optional wetting with additional solvent 19 over cover coat 18 may hasten the process.

Due to the manner in which the cover coat and solvent react, the decorative or informational decal 10 can be applied to both porous or non-porous geological formations and a variety of different textured cements and concretes.

While the present invention has been described with respect to the exemplary embodiments thereof, it will be recognized by those of ordinary skill in the art that many changes and modifications can be made without departing from the spirit and scope of the invention. Therefore it is manifestly intended that the invention be limited only by the claims and the equivalents thereof.

What is claimed:

1. A decal for decorating a geological formation, concrete structure, or other grainy or textured surface, said decal comprising:
a first layer of water permeable transfer paper;
a second layer release coating overlaying one side of said water permeable transfer paper;
a third layer of a pigment suspended in an oil medium to form a decorative design overlaying said release layer; and
a fourth layer cover coat overlaying said third layer of pigment and oil, said fourth layer being solvent reactive to form an adhesive with a geological formation or non-smooth surface.

2. The decal in accordance with claim 1 wherein said first coating of water permeable transfer paper comprises a stratum of paper stock having a high rate of water transmission.

3. The decal in accordance with claim 1 wherein said release layer comprises a water soluable release agent.

4. The decal in accordance with claim 3 wherein said release layer comprises gum arabic.

5. The decal in accordance with claim 1 wherein said pigment and oil medium comprises inorganic metallic color oxides suspended in an oil medium and coated on said release layer to form a decorative design or textual message.

6. The decal in accordance with claim 1 wherein said fourth layer cover coat comprises the group including acrylic, polyester, polyurethane or nitrocellulose cover coat.

7. The decal in accordance with claim 1 wherein said reactive solvent is from the class including turpentine, acetone, toluene, ether, alcohol, butylcellosolve, cellosolve, acetate and EB acetate.

8. A method for decorating a geological formation, concrete structure, or other grainy or textured surface with a decal comprising the steps of
a) fabricating a decal having a first layer of water permeable transfer paper overlaid with the second layer of release coating overlaid with a third layer of inorganic metallic color oxides suspended in an oil medium so as to form a design and overlaid with a fourth layer comprising a cover coat;
b) cleaning the surface to be decorated to remove dirt and debris;
c) coating the surface to be decorated with a solvent;
d) wetting the decal to remove the water permeable transfer paper and release layer;
e) contacting the third layer of inorganic metallic color oxides and oil medium with the solvent on the surface to be decorated;
f) pressing the decal to the shape of the surface;
g) allowing the solvent, cover coat, and oil medium to react to form an adhesive to adhere the inorganic metallic colored oxide image to the rock or other non-smooth surface.

9. The method in accordance with claim 7 wherein said solvent is from the class including turpentine, acetone, toluene, ether, alcohol, butylcellosolve, cellosolve, acetate and EB acetate.

10. The method in accordance with claim 7 wherein said cover coat comprises the class including acrylic, polyester, polyurethane or nitrocellulose cover coat.

11. A geological formation decorated in accordance with the method according to claim 7.

12. A concrete structure decorated in accordance with the method according to claim 7.
